(19) United States
(12) Patent Application Publication
(10) Pub. No.: US 2018/0246900 A1
(43) Pub. Date: Aug. 30, 2018

(54) FILE MANAGING METHOD AND SYSTEM THEREOF FOR INTEGRATED CIRCUIT DESIGN

(71) Applicants: GLOBAL UNICHIP CORPORATION, HSINCHU CITY (TW); TAIWAN SEMICONDUCTOR MANUFACTURING CO., LTD., HSINCHU (TW)

(72) Inventors: Hsien-Ming LIU, HSINCHU CITY (TW); Jye-Yuan LEE, HSINCHU CITY (TW); Yen-Hsiu HUANG, HSINCHU CITY (TW)

(21) Appl. No.: 15/701,432

(22) Filed: Sep. 11, 2017

(30) Foreign Application Priority Data
Feb. 24, 2017 (CN) 201710102293.8

(51) Int. Cl. G06F 17/30; G06F 17/50

(52) U.S. Cl. CPC G06F 17/30091; G06F 17/3023; G06F 17/5045

(57) ABSTRACT

A file managing method for design flows of integrated circuit design includes the following operations: assigning a first file to a first storage address by a processor, in which the first file is generated at a first stage of stages and the files generated in each stage have different versions; assigning a second file to a second storage address by the processor, in which the second file is generated at a second stage of the stages and the second file is generated based on the first file: generating data based on the first file, the second file, the first storage address, and the second storage address, by the processor, to reflect relevance between the first file and the second file; and when the first file or the second file is read, both of the first and second files are shown, based on the relevance data, by the processor.

### CROSS-REFERENCE TO RELATED APPLICATION

This application claims the priority benefit of China Application serial no. 201710102293.8, filed Feb. 24, 2017, the full disclosure of which is incorporated herein by reference.

### FIELD OF INVENTION

The invention relates to a file managing method and the system thereof. More particularly, the invention relates to a file managing method and the system thereof for managing the relevance between files used in an integrated circuit design.

### BACKGROUND

During development of products, products usually need to be developed by multiple developers at multiple design stages. For developers, it is important to consider how to take the appropriate method at each design stage to achieve a better price/performance ratio. Each file is developed according to one of the multiple files at the previous stage.

However, since the files are stored only in various folders at each stage or in the folder assigned by the developers, the developers have to remember and maintain the relevance between the various design files at different stages. The workload of the developers may increase and problems in development may be caused due to the excessive number of files and human error. Therefore, how to automatically record the relevance between the files of the various stages, are the problems needed to be addressed in the art.

### SUMMARY

An aspect of this disclosure is to provide a file managing method for a design process of an integrated circuit design. The file managing method includes the following operations: assigning a first file to a first storage address by a processor, in which the first file is generated at a first stage of a plurality of stages, and a plurality of files generated in each of the stages have different versions; assigning a second file to a second storage address by the processor, in which the second file is generated at a second stage of the stages, and the second file is generated according to the first file; generating relevance data according to the first file, the second file, the first storage address, and the second storage address, by the processor, in which the relevance data is configured to reflect a relevance between the first file and the second file: and showing both of the first file and the second file according to the relevance data, by the processor, when the first file or the second file is read.

Another aspect of this disclosure is to provide a file managing system for a design process of an integrated circuit design. The file managing system includes at least one memory and a processor. The at least one memory is configured to store a plurality of computer codes, relevance data, a first file, and a second file. The processor is configured to execute the computer codes, in order to display the first file and the second file on an input/output (I/O) interface according to the relevance data when the first file and the second file are read. The first file is generated at a first stage of a plurality of stages, the second file is generated at a second stage of the stages, the second file is generated according to the first file, and a plurality of files generated at each of the stages have different versions.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic diagram illustrating a file managing system according to some embodiments of the present disclosure.

FIG. 2A is a flow chart illustrating a file managing method according to some embodiments of the present disclosure.

FIG. 2B is a flow chart illustrating one of the operations in FIG. 2A according to some embodiments of the present disclosure.

FIG. 3 is a schematic diagram illustrating a directory tree according to some embodiments of the present disclosure.

FIG. 4 is a schematic diagram illustrating a relevance data according to some embodiments of the present disclosure.

### DETAILED DESCRIPTION

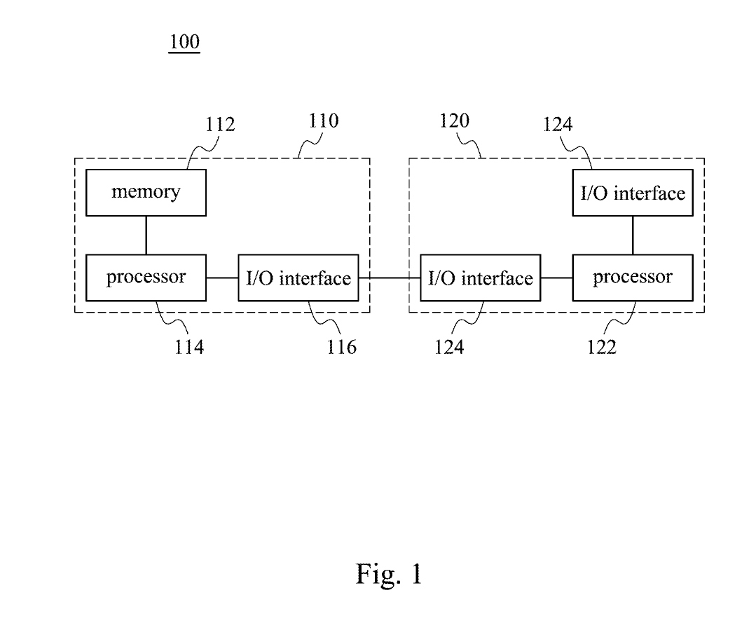

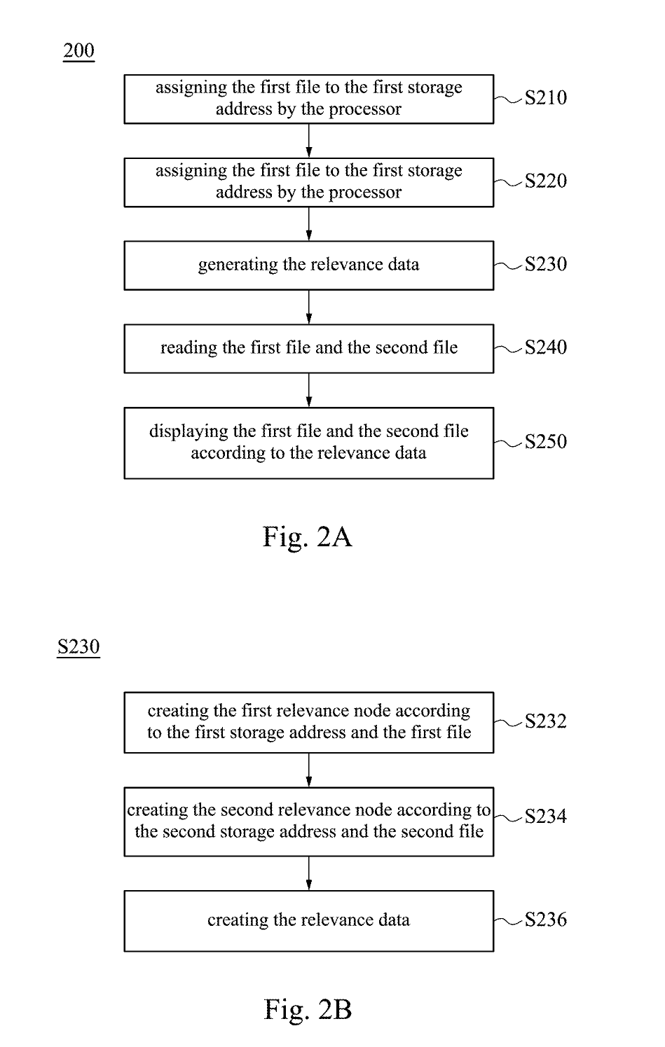

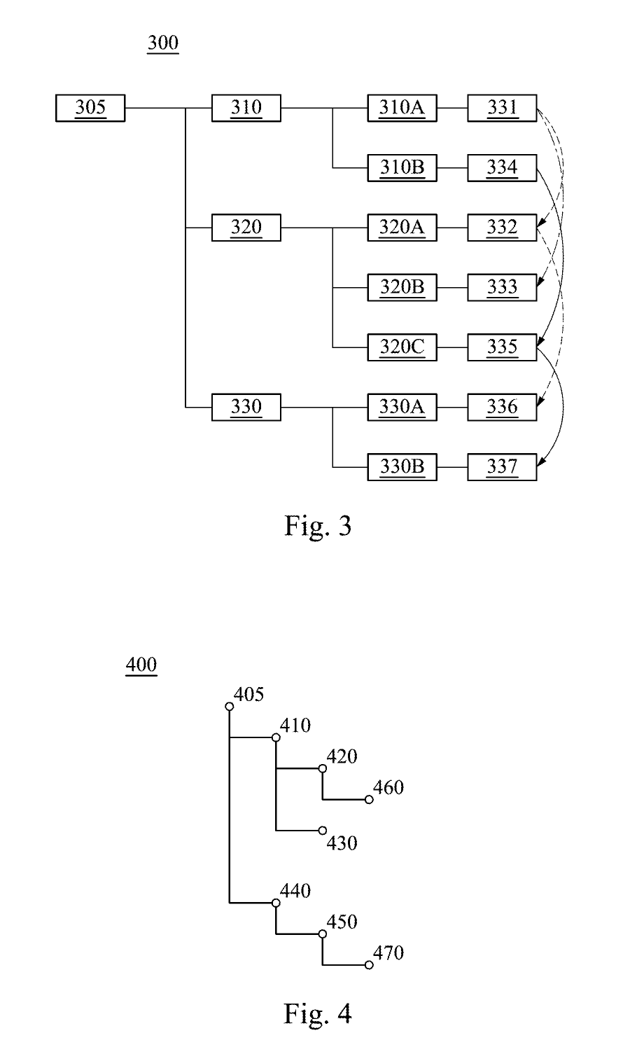

Reference is made to FIG. 1. FIG. 1 is a schematic diagram illustrating a file managing system 100 according to some embodiments of the present disclosure. The file managing system 100 includes a server 110 and an electronic device 120. In some embodiments, the file managing system 100 may be applied to a design process of an integrated circuit design, the server 110 may be a workstation for managing files of various circuit designs, and the electronic device 120 may be a personal computer operated by a circuit designer. The interoperability of the server 110 and the electronic device 120 will be described later with reference to the following FIG. 2A, FIG. 2B, FIG. 3, and FIG. 4. For facilitating the understanding, the setting of the file managing system 100 will be described first as shown below.

The server 110 includes a memory 112, a processor 114, and an input/output interface (I/O interface) 116. The memory 112 is coupled to the processor 114. The memory 112 may store the data transmitted by the processor 114. The processor 114 may read the data from the memory 112. The I/O interface 116 is connected to the processor 114. The I/O interface 116 and the processor 114 may transmit and/or receive data with each other. The electronic device 120 includes a processor 122 and several I/O interfaces 124. The processor 122 is connected to I/O interfaces 124. The processor 122 and the I/O interfaces 124 may transmit and/or receive data with each other. The I/O interface 116 of the server 110 is electrically coupled to one of the I/O interfaces 124 of the electronic device 120. The server 110 may be coupled to several electronic devices 120. The file managing system 100 illustrated in FIG. 1 is for illustrative purposes only and the present disclosure is not limited thereto.

In some embodiments of the present disclosure, the server 110 may be a cloud server, a community network server, a file server, or other server having the same functions such as storing, computing, data reading, etc.

In some embodiments of the present disclosure, one of the I/O interfaces 124 of the electronic device 120 may include an input device such as a keyboard, a mouse, a voice input element, or the like. Another one of the I/O interfaces 124 of the electronic device 120 may be a communication device. In some embodiments, the developers may input an instruction (for example, a first instruction or a second instruction as discussed later) through an input device.

In some embodiments of the present disclosure, the I/O interfaces 124 of the electronic device 120 may include communication devices to transmit data and/or instructions to and from the server 110. In various embodiments, the communication device may include a Bluetooth transport chip, a wireless network technology (WiFi) chip, a fourth generation mobile network communications (4G) chip, a third generation mobile network communications (3G) chip, a second generation mobile network communication (2G) chip, or other equivalent processing circuit.

In some embodiments of the present disclosure, another one of the I/O interfaces 124 of the electronic device 120 may be an output device, such as a liquid crystal display, a light emitting diode display, or the like.

In some embodiments of the present disclosure, the processor 114 and the processor 122 may be a central processing unit (CPU), a microprocessor (MCU), or other similar computing circuit or element.

In some embodiments, the memory 112 stores one or more codes (for example, including a first instruction and a second instruction, as described later) for assisting in managing multiple files. For example, the memory 112 stores a code encoded in several instruction sets, in which the instruction sets are used to manage multiple files with different versions. The processor 114 may execute the code stored in the memory 112, and several operations for managing multiple files may be automatically executed.

In some embodiments, the memory 112 may be implemented as a read-only memory, a flash memory, a floppy disk, a hard disk, a disc, a flash drive, a tape, a database accessible by the network. The technician can easily think about the storage device with the same function. For facilitating the understanding, FIG. 1 shows only a single memory 112. In different embodiments, the server 110 may include one or more memories for storing the aforementioned codes, multiple files, and the relevance data, respectively.

In some embodiments of the present disclosure, the electronic device 120 may be a smartphone, a personal computer, a tablet, a personal digital assistant, or the like.

The setting method of the file management system 100 mentioned above is merely an example. Various hardware that may implement the same functionality of the file managing system 100 are also within the scope of this disclosure. The following paragraphs will illustrate various embodiments of the file managing system 100 with reference to the figures, but the application of the file managing system 100 is not limited to the following embodiments.

FIG. 2A is a flow chart illustrating a file managing method 200 according to some embodiments of the present disclosure. The file managing method 200 is applicable to a development process including several operations as shown in FIG. 3, but the present disclosure is not limited thereto. The file managing method 200 includes operations S210 to S250.

For facilitating the understanding, reference is made to FIG. 3 first. FIG. 3 is a schematic diagram illustrating a directory tree 300 according to some embodiments of the present disclosure. As shown in FIG. 3, the directory tree 300 includes a top directory 305. The top directory 305 includes a first stage directory 310, a second stage directory 320, and a third stage directory 330. The first stage directory 310, the second stage directory 320, and the third stage directory 330 respectively represent the storage directories corresponding to the files of different stages in a multi-step development process. The files in each stage directories are developed according to at least one file in the directory of the previous stage.

Take an integrated circuit design and development process for example, the first stage corresponds to the initial stage of an integrated circuit design and development process. The first stage directory 310 is configured to store the initial files of the initial stage. For example, the first stage directory 310 includes subfolders 310A and 310B, wherein the file 331 is stored in the subfolder 310A, and the file 334 is stored in the subfolder 310B. The file 331 and the file 334 may include process files for designing an integrated circuit, design rule files, and the like.

The second stage corresponds to the layout stage (floorplan) of the integrated circuit design development process. The second stage directory 320 may be a file for storing the files generated during the layout planning stage. For example, the second stage directory 320 includes subfolders 320A, 320B, and 320C, in which the file 332 is stored in the subfolder 320A, the file 333 is stored in the subfolder 320B, and the file 335 is stored in the subfolder 320C. File 332, file 333 and file 335 are files representing the layout plan of the circuit, wherein file 332 is designed according to file 331 in the subfolder 310A of the first stage directory 310, file 333 is also designed according to file 331 in the subfolder 310A of the first stage directory 310, and file 335 is designed according to the file 334 in the subfolder 310B of the first stage directory 310.

The third stage corresponds to the component layout stage of the integrated circuit design and development process. The third stage directory 330 may be a file for storing the files generated according to the arrangement of the elements. For example, the third stage directory 330 includes subfolders 330A and 330B, where the file 336 is stored in the subfolder 330A, and the file 337 is stored in the subfolder 330B. The file 336 and the file 337 are the files representing the layout of the circuit elements in the layout plan, in which the file 336 is designed according to the file 332 in the subfolder 320A of the second stage directory 320, the file 337 is designed according to the file 335 in the subfolder 320C of the second stage directory 320.

In other words, as shown in FIG. 3, there is relevance between the file 331, the file 332, and the file 336. There is relevance between the file 334, the file 335, and the file 337. There is relevance between the file 331 and the file 333.

In some embodiments, multiple files in the same stage may be developed according to the same files in the previous stage. For example, as shown in FIG. 3, the file 333 and the file 332 in the second stage directory 320 are developed according to the file 331 in the first stage directory 310. For example, the file 332 and the file 333 are all files representing the layout plan of the circuit, and both files are designed according to the file 331 in the first stage directory 310. In other words, the file 333 and the file 332 represent circuit files representing different versions of the circuit layout plan.

In some embodiments, each stage directory includes at least one file, and different files in the same stage may represent different versions developed in the same stage. For example, as shown in FIG. 3, the file 331 and the file 334 in the first stage directory 310 respectively represent the different versions of the files developed in the first stage. The file 332, the files 333, and the file 335 in the second stage directory 320 respectively represent the different versions of the files developed in the second stage. The file 336 and the file 337 in the third stage directory 330 respectively represent the different versions of the files developed in the third stage.

In the existing technology, the file managing system will only show all the files located in the top directory 305 for the user to browse. In some related technologies, as previously described, such a development process with multiple stages and multiple different versions of the files requires the user to memorize the file relevance between the various files. As a result, the subsequent design or maintenance is inconvenience. Compared with these techniques, the file managing system 100 may automatically establish the relevance between the files in order to improve the efficiency of the subsequent design and maintenance by the multiple operations as described later with FIG. 2A.

In some embodiments, the top directory 305, the first stage directory 310, the second stage directory 320, and the third stage directory 330 may represent a virtual folder, a memory address or the like stored in a database of the memory 112 in FIG. 1. It is to be noted that the names of the directories shown in FIG. 3 are for illustrative purposes only and that different names of the directories are within the expected scope of the disclosure.

The directory tree 300 shown in FIG. 3 is merely for illustrative purposes, but the present disclosure is not limited thereto. Different types of directory trees or different file storage addresses are within the expected scope of this disclosure. For facilitating the understanding, the above stages and files are only examples of the circuit design process, but the present disclosure is not limited thereto.

Reference is made to FIG. 1, FIG. 2A and FIG. 3 together. In operation S210, the processor 114 assigns the file 331 to the first storage address. As shown in FIG. 3, file 331 is one of the multiple files developed in the first stage.

In some embodiments, the processor 114 responds to the first instruction to assign the file 331 to the first storage address. In some embodiments, the first instruction is generated by the processor 122 of the electronic device 120 and is transmitted to the server 110 through one of the I/O interfaces 124 of the electronic device 120. In some other embodiments, the designer may enter a first instruction via one of the I/O interfaces 124 of the electronic device 120, and the first instruction is transmitted to the processor 122. Accordingly, the processor 122 may then transmit the first instruction to the server 110 via another one of the I/O interfaces 124 of the electronic device 120.

For example, in some embodiments, the file managing system 100 may generate multiple instructions in conjunction with a subversion control tool. In an example, in operation S210, the server 110 may continuously execute the following first instruction associated with the version control tool under the path corresponding to the first stage directory 310.
>evc create TOP/INITDATA/ECO1 (1; )
>evc commit name-1.file (2)

The description (1) of the first instruction represents the creation of a virtual first storage address in the first stage directory 310. The first storage address corresponds to the subfolder 310A in FIG. 3, with the name of ECO1. TOP represents the name of the top directory 305 in FIG. 3, and INITDATA represents the name of the first stage directory 310. The description (2) of the first instruction represents assigning the file 331 to the first storage address, in which the subfolder 310A corresponds to the first storage address. name-1.file represents the file name corresponding to file 331. In some embodiments, the subfolder 310A is set in a storage path. The storage path stores all the files belonging to the same version among the files generated in the first stage.

The first instruction as described above may include instructions for creating a directory address, a folder name, or for storing information. In addition, for facilitating the understanding, only a single file 331 is illustrated above, but the number of files stored in the subfolder 310A may be one or more, and the version of the files stored in the subfolder 310A is the same as the file 331.

In some embodiments, in operation S210, the first instruction is transmitted to the processor 122, and then the first instruction is transmitted to the server 110 through one of the I/O interfaces 124. After the server 110 receives the first instruction, the processor 114 stores the file 331 to the storage address corresponding to the folder name in the database of the memory 112, according to the folder name in the first instruction.

In some other embodiments, the processor 114 first determines whether a storage address corresponding to the folder name in the first instruction has existed in the memory 112 of the server 110. If the corresponding storage address exists, the processor 114 stores the file 331 in the storage address in the database of the memory 112, in which the storage address corresponds to the folder name. If the corresponding storage address does not exist, the processor 114 may first create a storage address corresponding to the folder name in the first instruction in the memory 112, according to the description (1) in the above described first instruction. Subsequently, the processor 114 stores the file 331 in the storage address in the database of the memory 112 according to the description (2) of the first instruction as described above, in which the storage address corresponds to the folder name.

Reference is made to FIG. 2A again. In operation S220, the processor 114 assigns the file 332 to the second storage address. As shown in FIG. 3, file 332 is one of the multiple files developed in the second stage. Among them, the file 332 is developed according to the previous stage of the file 331. In some embodiments, the processor 114 responds to the second instruction to assign the file 332 to the second storage address.

For example, in the example of the aforementioned version control tool described above, the file managing system 100 may generate several instructions in conjunction with a version control tool. In operation S220, the server 110 may continuously execute the following second instruction associated with the version control tool under the path corresponding to the second stage directory 320.
>evc create TOP/FLOORPLAN/FP2 (3)
>evc commit name-2.file (4)

The description (3) of the second instruction represents the creation of a virtual second storage address in the second stage directory 320. The second storage address corresponds to the subfolder 320A in FIG. 3, with the name of FP2. TOP represents the name of the top directory 305 in FIG. 3, and FLOORPLAN is the name of the second stage directory 320. The description (4) of the second instruction represents the corresponding to assigning the file 332 to the second storage address, in which the subfolder 320A corresponds to the second storage address. name-2.file represents the file name corresponding to file 332. In some embodiments, the subfolder 320A is set in a storage path of all the files belonging to the same version among the files generated in the second stage.

The second instruction as described above may be an instruction containing creating a directory address, a folder name, or storing information. In addition, for facilitating the understanding, only a single file 332 is described above for illustrative purposes, but the number of files stored in the subfolder 320A may be one or more, and the versions of the files stored in the subfolder 320A are the same as the file 332.

In some embodiments, the electronic device 120 may access the file 331 stored in the server 110. Accordingly, the file 331 may be developed as the file 332 with the electronic device 120, and the electronic device 120 may store the file 332 in the memory 112 of the server 110 through operation S220.

Reference is made to FIG. 2A. In operation S230, the relevance data is generated. For facilitating the understanding operation S230, reference is made to FIG. 2B and FIG. 4. FIG. 2B is a flow chart illustrating operation S230 according to some embodiments of the present disclosure. FIG. 4 is a schematic diagram, illustrating a relevance data 400 according to some embodiments of the present disclosure. In some embodiments, the relevance data 400 is stored in the database of the memory 112 (showed in FIG. 1). The presentation of the relevance data 400 is for illustrative purposes only, and various relevance data including the same concepts are within the intended scope of the present disclosure.

As illustrated in FIG. 2B, operation S230 includes operations 5232, 5234, and S236. First, in operation S232, the relevance node 410 is created according to the first storage address and the file 331.

In some embodiments, the processor 114 (showed in Fing.1) generates the relevance data according to the aforementioned first instruction. For example, the processor 114 creates a relevance node 410 according to the first storage address in the first instruction (for example, the address corresponding to the aforementioned subfolder 310A) and the file 331. The relevance node 410 diverges from the relevance node 405. In some embodiments, the relevance node 405 may represent the origin or starting point of the entire development process. For example, in this example, the relevance node 405 corresponds to the storage address corresponding to the top directory 305 in FIG. 3.

In operation S234, the relevance node 420 is created according to the second storage address and the file 332.

For example, in some embodiments, the processor 114 generates the relevance data according to the aforementioned second instruction. For example, the processor 114 creates the relevance node 420 according to the second storage address in the second instruction (for example, the address corresponding to the subfolder 320A) and the file 332.

In operation S236, the relevance data 400 is created. In some embodiments, the relevance data 400 is automatically created by the processor 114 according to a first instruction and a second instruction. The relevance data 400 has dependency information between the files. For example, since file 332 is generated according to file 331, there is a dependency between file 332 and file 331. Thus, there is a corresponding dependency between the relevance node 420 and the relevance node 410. Thus, in the relevance data 400, the dependency between the relevance node 420 and the relevance node 410 is displayed. For example, in some embodiments, the relevance node 420 may diverge from the relevance node 410 and connect to each other.

In some embodiments, the creation of the dependency between the relevance node 420 and the relevance node 410 is automatically created by the processor 114 in the relevance data 400. In some embodiments, for example, the processor 114 determines that the file 332 is developed according to the file 331, and then the processor 114 connects the relevance node 420 to the relevance node 410 when the relevance data 400 is created.

In some embodiments, the relevance node corresponds to a file storage address. For example, the relevance node 410 corresponds to the first storage address of the file 331, and the relevance node 420 corresponds to the second storage address of the file 332.

Reference is made to FIG. 2A and Fing.1. After executing operation S230, in operation S240, the file 331 or the file 332 is read. In some embodiments, the reading of file 331 or file 332 is executed by processor 114. In some embodiments, the server 110 receives the instructions transmitted from the electronic device 120 through the I/O interface 116. and then the processor 114 reads the file 331 or file 332 from the memory 112 according to the instruction.

In operation S250, the file 331 and the file 332 are displayed according to the relevance data 400. In some embodiments, the processor 114 determines that there is a dependency between the file 331 and the file 332 according to the relevance data 400. Thus, when any of the file 331 and the file 332 is read, the processor 114 also reads information about another file (for example, storage address, file name, etc.) so as to provide the user for viewing. The processor 114 then transmits the relevant information of the file 331 and the file 332 to the electronic device 120 through the I/O interface 116. One of the I/O interfaces 124 of the electronic device 120 may thus display information about the file 331 and the file 332 to the user for viewing.

For example, in some embodiments of the present disclosure, one of the I/O interfaces 124 of the electronic device 120 may be a keyboard, and one of the I/O interfaces 124 of the electronic device 120 may be a communication device. The other one of the I/O interfaces 124 of the electronic device 120 may be a display. In the above example, the user may input a command through the keyboard to assign the file to be read, and the processor 122 displays the folder that the file 331 and the file 332 stored in via the display, according to the relevant information about the file 331 and the file 332.

For example, when the user assigns to read file 331 through the keyboard, the communication device of the electronic device 120 transmits an instruction to the server 110. The processor 114 in the server 110 then executes operation S240 to read the relevant information of the file 331. After the processor 114 executes operation S240, the processor 114 executes operation S250. That is, the processor 114 determines that there is a dependency between the file 331 and the file 332, according to the relevance data 400, so that the processor 114 reads the relevant information of the file 332 together. The processor 114 then transmits information about both the file 331 and the file 332 to the electronic device 120 through the I/O interface 116 to display information about the file 331 and the file 332 via the display of the electronic device 120.

In some embodiments, in operation S250, all of the files that are directly dependent or indirectly dependent on the files read in operation S240 are displayed according to the relevance data 400.

Reference is made to FIG. 3 and FIG. 4 together. The relevance node 410 is created according to the file 331 and the first storage address. The relevance node 420 is created according to the file 332 and the second storage address. Other relevance nodes 430 to 470 may be created as a like.

As shown in FIG. 4 there is a direct dependency between the relevance node 410 and the relevance node 420. There is a direct dependency between the relevance node 420 and the relevance node 460. There is an indirect dependency between the relevance node 410 and the relevance node 460. There is a direct dependency between the relevance node 450 and the relevance node 470. There is a direct dependency between the relevance node 440 and the relevance node 450. There is an indirect dependency between the relevance node 440 and the relevance node 470.

In some embodiments, when there is a direct dependency between multiple relevance nodes, the files and/or the storage addresses corresponding to each of the relevance nodes are directly dependent on each other. For example, as shown in FIG. 4, there is a direct dependency between the relevance node 410 and the relevance node 420, indicating a direct dependency between subfolder 310A and subfolder 320A. Equivalently, there is a direct dependency between the file 331 stored in the subfolder 310A and the file 332 stored in the subfolder 320A, and so on. Similarly, in other embodiments, when there is an indirect dependency between multiple relevance nodes, the files and/or the storage addresses corresponding to the relevance nodes are indirectly dependent on each other.

For example, reference is made to FIG. 3 and FIG. 4, in some embodiments of the present disclosure, when the file 331 is read by the processor 114 (showed in FIG. 1), according to the association data 400, file 332 and file 333, which are directly dependent on the file 331, and the file 336, which is indirectly dependent on the file 331, are read by the processor 114. As described above, in operation S250, the relevant information of the file 331, the file 332, the file 336, and the file 333 may be displayed to the user via the display.

Reference is made to FIG. 3 and FIG. 4 again. In some embodiments, when the file 337 is read, the processor 114 (showed in FIG. 1) will read the file 335 and the file 334, which are directly or indirectly dependent on the file 337, according to the relevance data 400. Accordingly, as described above, in operation S250, the information of the file 337, the file 335, and the file 334 may be displayed via the display.

The instructions in the examples above are only examples of the encoding of the version control tool. Other encodings or control tools applicable to the file managing system 100 (showed in FIG. 1) are within the scope of the present disclosure.

In addition, the above illustrations comprise sequential demonstration operations, but the operations need not be performed in the order shown. The execution of the operations in a different order is within the scope of this disclosure. In the spirit and scope of the embodiments of the present disclosure, the operations may be increased, substituted, changed and/or omitted as the case may be.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A file managing method for a design process of an integrated circuit design, comprising:
assigning a first file to a first storage address by a processor, wherein the first file is generated at a first stage of a plurality of stages, and a plurality of files generated in each of the stages have different versions;
assigning a second file to a second storage address by the processor, wherein the second file is generated at a second stage of the stages, and the second file is generated according to the first file;
generating relevance data according to the first file, the second file, the first storage address, and the second storage address, by the processor, wherein the relevance data is configured to reflect a relevance between the first file and the second file; and
showing both of the first file and the second file according to the relevance data, by the processor, when the first file or the second file is read.

2. The file managing method of claim 1, wherein assigning the first file comprises:
assigning the first file to the first storage address in response to a first instruction, wherein the first storage address is a storage address in a database, wherein all files belonging to the same version among files generated in the first stage are stored in the first storage address.

3. The file managing method of claim 2, wherein assigning the first file further comprises:
creating the first storage address in response to the first instruction.

4. The file managing method of claim 1, wherein generating the relevance data comprises:
creating a first relevance node according to the first storage address and the first file;
creating a second relevance node according to the second storage address and the second file; and
creating the relevance data according to a dependency between the first relevance node and the second relevance node.

5. A file managing system for a design process of an integrated circuit design, comprising:
at least one memory configured to store a plurality of computer codes, relevance data, a first file, and a second file; and
a processor configured to execute the computer codes, in order to display the first file and the second file on an input/output (I/O) interface according to the relevance data when one of the first file and the second file is read,
wherein the first file is generated at a first stage of a plurality of stages, the second file is generated at a second stage of the stages, the second file is generated according to the first file, and a plurality of files generated at each of the stages have different versions.

6. The file managing system of claim 5, wherein the processor is further configured to execute the computer codes, in order to:
create the relevance data according to the first file, a first storage address relevant to the first file, the second file, and a second storage address relevant to the second file.

7. The file managing system of claim 6, wherein the processor is further configured to response to a first instruction to create the first storage address and assign the first file to the first storage address; and
wherein the first storage address is a storage address in the at least one memory, and all files belonging to the same version among files generated in the first stage are stored in the first storage address..

8. The file managing system of claim 6, wherein the processor is further configured to execute the computer codes, in order to:
create a first relevance node according to the first storage address and the first file;
create a second relevance node according to the second storage address and the second file; and
create the relevance data according to a dependency between the first relevance node and the second relevance node.
